(19) United States
(12) Patent Application Publication
(10) Pub. No.: US 2013/0009971 A1
(43) Pub. Date: Jan. 10, 2013

(54) IMAGE PROCESSING APPARATUS, PREVIEW IMAGE DISPLAYING METHOD, AND RECORDING MEDIUM

(75) Inventors: Tomoko MARUYAMA, Toyokawa-shi (JP); Toshimi Shinchi, Toyokawa-shi (JP); Takuya Okada, Toyokawa-shi (JP); Koichi Amiya, Anjo-shi (JP); Kenichi Komaba, Toyokawa-shi (JP)

(73) Assignee: KONICA MINOLTA BUSINESS TECHNOLOGIES, INC., Chiyoda-ku (JP)

(21) Appl. No.: 13/535,719

(22) Filed: Jun. 28, 2012

(30) Foreign Application Priority Data
Jul. 7, 2011 (JP) 2011-151306

(51) Int. Cl. G06T 1/00

(52) U.S. Cl. 345/522; 345/501

(57) ABSTRACT

An image processing apparatus comprises: an image processor which performs a plurality of image processing operations on one target data object separately; a display; and a controller which extracts from the target data object a plurality of data sections changed by the image processing operations of the image processor and displays the extracted data sections all together on the display as preview images.

This application claims priority under 35 U.S.C. §119 to Japanese Patent Application No. 2011-151306 filed on Jul. 7, 2011, the entire disclosure of which is incorporated herein by reference in its entirety.

### BACKGROUND OF THE INVENTION

1. Field of the Invention

The present invention relates to an image processing apparatus which is capable of displaying preview images prior to performing image processing operations on a target data object such as a document image; a preview image displaying method for the image processing apparatus; and a recording medium with a program of displaying a preview image, being stored thereon.

2. Description of the Related Art

The following description sets forth the inventor's knowledge of related art and problems therein and should not be construed as an admission of knowledge in the prior art.

Some image processing apparatus such as MFPs (Multi Function Peripherals) which are multifunctional digital image forming apparatuses collectively having a copier, printer, facsimile, and other functions, further have a preview function, and such image processing apparatuses are known.

Having the preview function, the MFPs allow specifying an image processing operation to perform on a target data object and previewing an image to be obtained by the image processing operation, by merging results of the specified operation to the target data object. The MFPs also allow viewing this preview image at a higher magnification (Japanese Unexamined Patent Publications No. 2010-130333 and No. 2009-302759).

The MFPs are sometimes configured to perform multiple and different image processing operations on one target data object separately.

For example, the MFPs further have a function of transmitting a facsimile (also referred to as FAX) along with a name or number in the header, being edited if another transmitter identification (TTI) is specified and a function of broadcasting one document along with different transmitter identifications depending on the recipient address. The MFPs further have a function of performing image processing operations to which a particular Box (storage area) is connected in advance, on a target data object, when storing the target data object on the particular Box.

Suggested in Japanese Unexamined Patent Publication No. H09-130575 is an image processing apparatus which is configured to give a specified one among pattern images registered in advance, to a target section of an image inputted and display a plurality of thumbnails (of some or all of the registered pattern images) so that they can be distinguished from one to another in an easier manner.

However, these MFPs display only an image to be obtained by one image processing operations, as a preview image at a time; in order to preview a plurality of images to be obtained by a plurality of image processing operations to which a particular Box or recipient address is connected in advance, it would be therefore necessary to repeat the following actions various times: selecting a preview image; specifying a data section; viewing it at a higher magnification; and returning to select another preview image, which is pretty troublesome.

When a MFP which is configured to display a plurality of thumbnails as described above is further configured to perform a plurality of image processing operations on one target data object separately, it would be difficult to preview images and recognize changes in thumbnails corresponding to data sections changed by the image processing operations, if the thumbnails are too small. Even when the MFP is further configured to display a plurality of thumbnails all in the same size or at the same magnification, it would still be troublesome to recognize changes in the thumbnails, including unnecessary ones, if the thumbnails show different data sections or the thumbnails are different in size.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

A first aspect of the present invention relates to an image processing apparatus comprising:

an image processor which performs a plurality of image processing operations on one target data object separately;

a display; and

a controller which extracts from the target data object a plurality of data sections changed by the image processing operations of the image processor and displays the extracted data sections all together on the display as preview images.

A second aspect of the present invention relates to a preview image displaying method for the image processing apparatus, comprising:

performing a plurality of image processing operations on one target data object separately; and

extracting from the target data object a plurality of data sections changed by the image processing operations of the image processor and displaying the extracted data sections all together on a display as preview images.

A third aspect of the present invention relates to a recording medium with a preview image displaying program being stored on an image processing apparatus to make a computer of the image processing apparatus execute:

performing a plurality of image processing operations on one target data object separately; and

extracting from the target data object a plurality of data sections changed by the image processing operations of the image processor and displaying the extracted data sections all together on a display as preview images.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram illustrating a configuration of an image processing apparatus according to one mode of implementing the present invention;

FIG. 2 is a flowchart representing a main processing routine to perform a plurality of image processing operations on one target data object separately, extract data sections changed by the image processing operations, and display the extracted data sections all together as preview images;

FIG. 3 is an example illustrating preview images to be displayed when transmitting a facsimile;

FIG. 4 is an example illustrating preview images to be displayed when storing a document on Boxes registered in advance;

FIG. 5 is an example illustrating preview images to be displayed when storing a document on the Boxes for which a plurality of image processing operations are predetermined;

FIG. 6 is an example illustrating preview images to be displayed when data sections to preview are specified by user;

FIG. 7 is an example illustrating title lines and display areas when hiding preview images;

FIG. 8 is an example illustrating preview images to be displayed when extending one of the display areas; and

FIG. 9 is an example illustrating preview images to be displayed when reducing one of the display areas.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, a mode of implementing the present invention will be described with reference to the accompanying drawings.

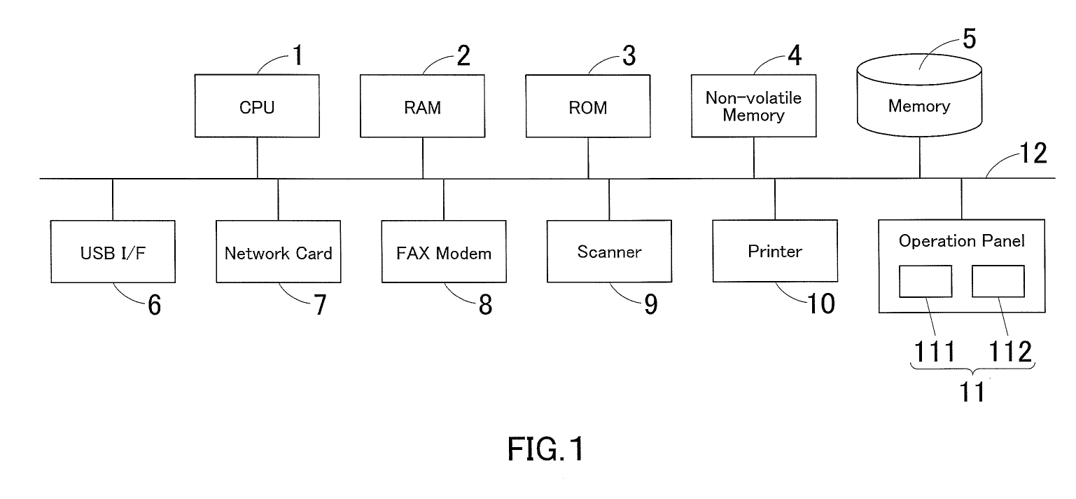

FIG. 1 is a block diagram illustrating an electrical configuration of an image forming apparatus according to one mode of implementing the present invention. In this mode of implementation, an image processing apparatus such as a MFP which is referred to as multifunctional digital image forming apparatus as described above is employed as an image processing apparatus.

As illustrated in FIG. 1, the MFP is provided with: a CPU 1, a RAM 2, a ROM 3, a non-volatile memory 4, a memory 5, a USB interface (I/F) 6, a network card 7, a FAX modem 8, a scanner 9, a printer 10, and an operation panel 11, all of which are connected to a bus 12.

The CPU 1 serves as a controller comprehensively controlling all the basic operations of the MFP: a copy, print, FAX transmission and receipt, scanning, and other operations. Furthermore, in this mode of implementation, the CPU 1 performs a plurality of image processing operations specified in advance on one target data object (the same target data object) separately; extracts data sections changed by the image processing operations; and displaying them all together on a display 112 of the operation panel 11, as a plurality of preview images. These operations will be later described in detail.

The RAM 2 provides a work area for the CPU 1 to execute processing.

The ROM 2 stores operation programs for the CPU 1 and other data.

The non-volatile memory 4 stores watermarks, ground patterns, and other data options to be given to target data objects in image processing operations.

The memory 5, which is composed of, for example, a hard disk drive, stores image data read out from a document by the scanner 9, print data received from an external device such as a user terminal, and FAX data externally received, and other data. There are a plurality of memory areas, also referred to as Boxes, prepared in the memory 5, and various data files can be sorted in the Boxes.

The USB interface 6 serves to exchange data with a device connected by USB.

The network card 7 serves to exchange data with: a user terminal which is composed of a personal computer; and a server (neither of them is illustrated in FIG. 1) which are both connected to the network.

The FAX modem 8 is a modulator and demodulator serving to transmit and receive FAX to and from a specified address.

The scanner 9 is an image reader reading an image of a document placed on a platen glass to convert to an image data format which is a digital image format.

The printer 10 is an engine printing out on paper, image data read out from a document by the scanner 9, print data externally received from the network, and other data.

The operation panel 11 is composed of a Start key, a Stop key, a keypad 11 with hardware keys such as number keys, and a display 112 such as a Liquid Crystal Display with touch-panel functionality. In this mode of implementation, the operation panel 11 also serves as a console for user to give an instruction to specify a data section to preview.

When performing a plurality of image processing operations on one target data object separately, the MFP displays data sections changed by the image processing operations, on a screen of the display 112. By touching on the screen of the display 112, user is allowed to preview them all together at a higher magnification, lower magnification, and different positions.

The target data object is any of the following ones: [1] an image read out from the memory 5 storing images; [2] an image received by the USB interface 6 externally from an USB device; [3] an image received by the network card 7 from a user terminal or a server; [4] an image received by the FAX modem 8; and [5] an image read out by the scanner 9 from a document, but it is not limited to them.

After image processing operations, the target data object will be outputted by any of the following actions: [1] storing on the memory 5; [2] transmitting to an external USB device via the USB interface 6; [3] transmitting to a user terminal or a server via the network card 7; [4] transmitting to a specified address via the FAX modem 8; and [5] printing out on paper by the printer 10.

The MFP as described above has a function of performing multiple and different image processing operations on one target data object separately. Using this function, the MFP extracts data sections changed by the image processing operations from a target data object; and displaying the extracted data sections all together as preview images in a list form, for example in an accordion structure, on the display 112.

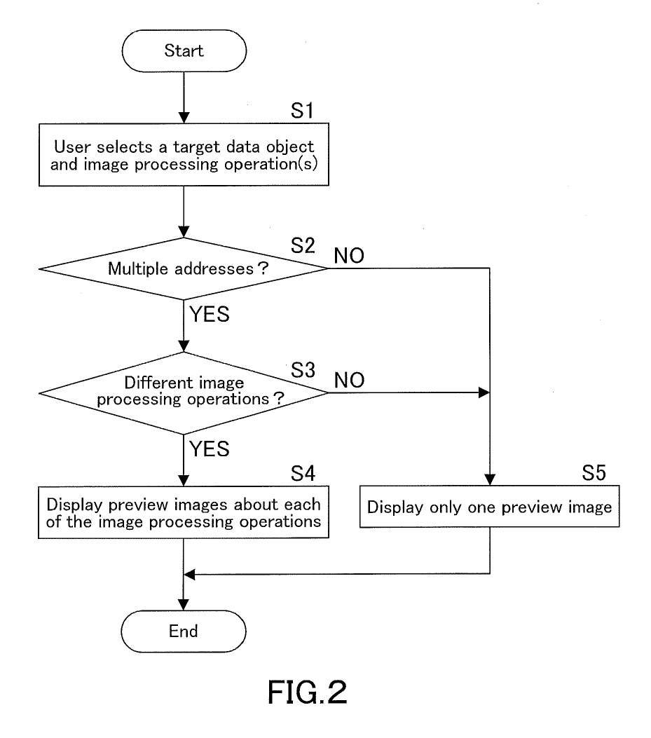

FIG. 2 is a flowchart representing a main processing routine to perform a plurality of image processing operations on one target data object separately, extract data sections changed by the image processing operations, and display the extracted data sections all together in a list form as preview images. This processing routine is executed by the CPU 1 of the MFP according to an operation program stored on a recording medium such as the ROM 3.

In Step S1, a target data object and an image processing operation(s) are specified by user. Then it is judged in Step S2 whether or not the image will be outputted to multiple addresses after the image processing operation(s). If it will not be outputted to multiple addresses (NO in Step S2), this means that only one image processing operation has been specified by user. In Step S5, only one preview image is therefore generated and displayed on the display 112 of the operation panel 11.

If it will be outputted to multiple addresses (YES in Step S2), then it is judged in Step S3 whether or not different image processing operations have been specified depending on the destination. If different image processing operations have not been specified depending on the destination (NO in Step S3), only one preview image is therefore generated and displayed on the display 112 of the operation panel 11.

If different image processing operations have been specified depending on the destination (YES in Step S3), data sections changed by the image processing operations are extracted from the target data object, and the extracted data sections are displayed on the display 112 of the operation panel 11 all together in a list form as preview images, in Step S4. A plurality of entire documents to be obtained as results of the image processing operations, including the target data object, may be generated while only the data sections are displayed as preview images. Alternatively, the data sections may be generated and displayed as preview images.

Hereinafter will be described in detail an example in which the MFP performs a plurality of image processing operations on a target data object separately and displays data sections changed by the image processing operations as preview images.

In this example, the MFP displays FAX headers to be given to a target data object (FAX document) as preview images when transmitting a FAX.

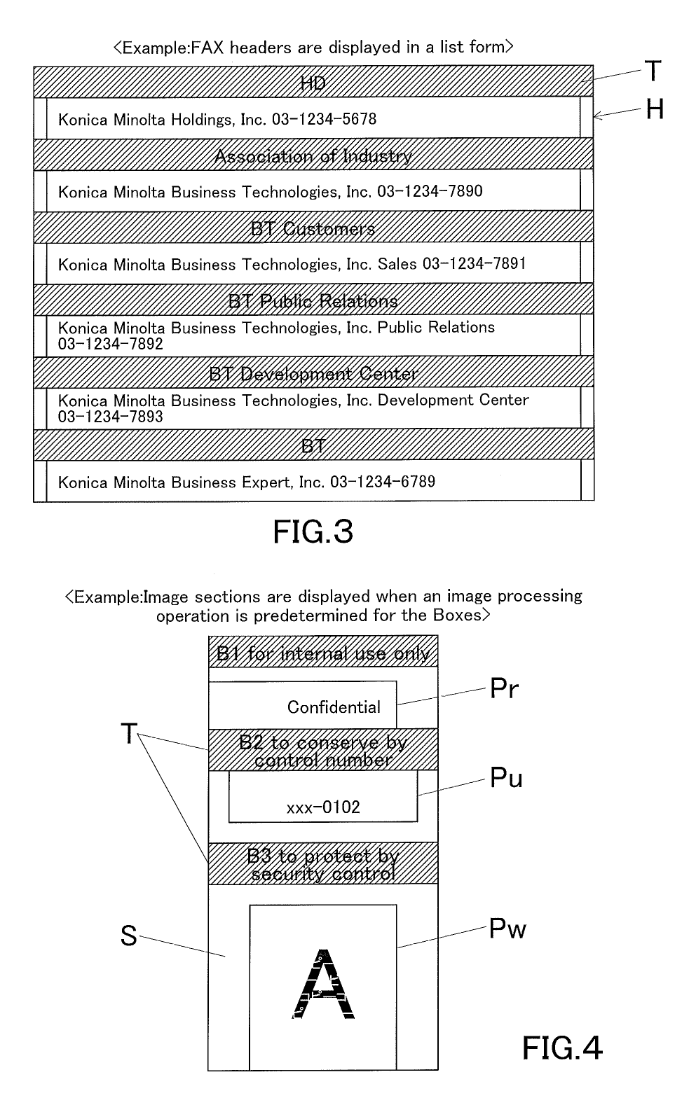

FIG. 3 is an example illustrating headers H, which is sender information (also referred to as TTI) different depending on the recipient address, to be displayed when transmitting one FAX document to multiple addresses.

There are multiple sender addresses registered in advance on a recording medium such as the non-volatile memory 4 of the MFP, and user is allowed to select one of them for each recipient address when transmitting a FAX document.

[1] For the first recipient address (“HD” is given to the title line T for example), “Konica Minolta Holdings, Inc.” is selected as a sender address.

[2] For the second recipient address (“Association of Industry” is given to the title line for example), “Konica Minolta Business Technologies, Inc.” is selected as a sender address.

[3] For the third recipient address (“BT Customers” is given to the title line for example), “Sales Department, Konica Minolta Business Technologies, Inc.” is selected as a sender address.

Similarly, sender addresses are selected for all the following recipient addresses.

The MFP stores the sender addresses along with connection to particular recipient addresses each having its own speed dialing number and/or particular delivery lists each having its own group number. User may be allowed to freely enter a new sender address on the MFP instead of selecting among them.

As described above, in this example, different sender addresses and FAX numbers will be given to the headers H by the image processing operation when transmitting one FAX document to multiple addresses. The headers H, which are data sections changed by the FAX operation, are therefore extracted and displayed on the display 112 as preview images at a higher magnification as illustrated in FIG. 3. The FAX document is not displayed because it should be identical for all recipient addresses.

As described above, in this mode of implementation, a plurality of data sections changed (only the headers H) are displayed all together in a list form as preview images. Therefore, it would not be necessary any more to repeat the following actions for all recipient addresses: selecting a preview image including a target data object; viewing it at a higher magnification; and returning to select another preview image. That would make it easier for user to confirm a sender address and recognize a change about each of the recipients. Displaying only the headers H, the data sections changed would allow more preview images in a limited display area and ensure a good visibility unlike the case in which thumbnails showing entire documents are too small. That would make it easier for user to preview images and recognize changes about all the image processing operations.

FIG. 4 is an example illustrating preview images to be displayed when one target data object is stored on a plurality of Boxes registered in advance on the memory 5. In this example, an image is read out from a document by the scanner 9, the obtained image is stored on a plurality of Boxes B1, B2, and B3 which are designated.

These Boxes can be predetermined as follows:

[1] The Box B1 stores target data objects for internal use only. Giving a watermark stating “Confidential” to the top right region of page Pr is the image processing operation predetermined for the Box B1.

[2] The Box B2 stores target data objects to conserve by a control number. Giving a file number “XXX-0102” to the bottom region of page Pu is the image processing operation predetermined for the Box 2.

[3] The Box B3 stores target data objects not for internal use. Giving a ground pattern repeating “Copy” to the entire page Pw is the image processing operation predetermined for the Box B3.

The image processing operations predetermined for the Boxes B1, B2, and B3 are performed when an target data object is stored thereon, respectively.

More specifically, as illustrated in FIG. 4, when a target data object is stored on the Box B1, a watermark is given to the top right region Pr of the target data object, and a data section showing the string “Confidential” in the top right region Pr at a higher magnification is displayed on the display 112 as a preview image.

When a target data object is stored on the Box B2, a file number (“XXX-0102” for example) is given to the bottom region Pu of the target data object, and a data section showing the file number in the bottom region Pu is displayed on the display 112 as a preview image.

When a target data object is stored on the Box B3, a ground pattern is given to the entire page Pw of the target data object, and a data section showing the ground pattern in the entire page Pw is displayed on the display 112 as a preview image.

Also in the mode of implementation of FIG. 4, a plurality of data sections changed by image processing operations are displayed all together in a list form as preview images. Therefore, it would not be necessary any more to repeat the following actions for all the image processing operations: selecting a preview image; viewing it at a higher magnification; and returning to select another preview image. That would make it easier for user to preview images and recognize changes about all the image processing operations. Displaying only the data sections changed would ensure a good visibility unlike the case in which thumbnails showing entire documents are too small. That would make it easier for user to preview images and recognize changes about all the image processing operations.

Here, the data sections show different regions of page, for example: entire page, center region, top right region, and bottom region, depending on the image processing operation; also the data sections are displayed in different sizes depending on the image processing operation. The display areas S can be adjusted to the image processing operations. For example, in FIG. 4, the display area S for the Box B3 is extended so as to show a large data section which is an entire page. By adjusting the display areas S to the image processing operations in this way above, perfect preview images, which are suitable for the regions of page to be shown in the data sections and the sizes of the data sections, can be displayed.

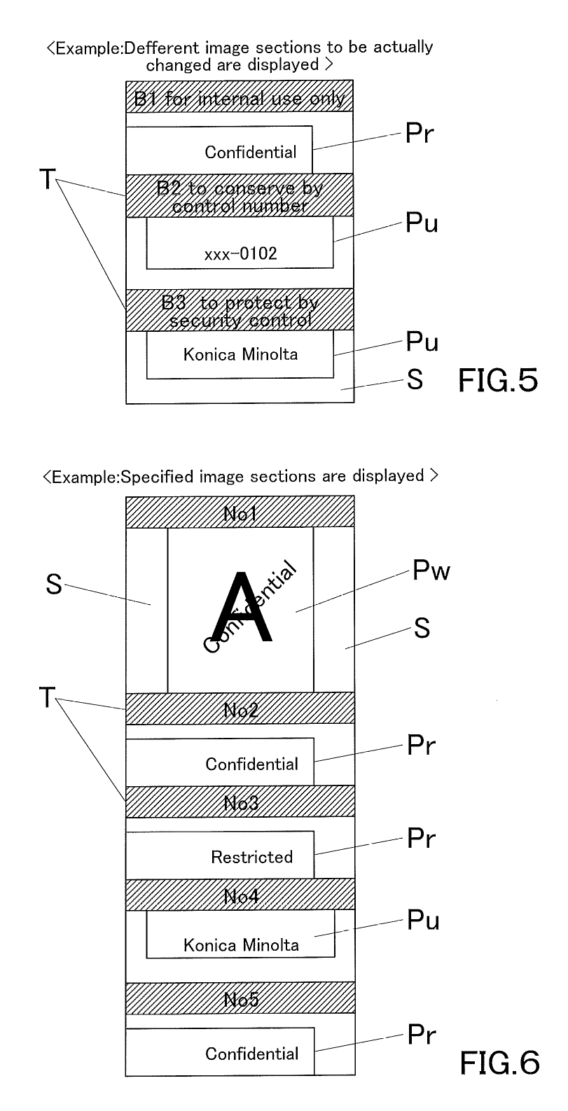

FIG. 5 is an example illustrating preview images to be displayed when storing a document on the Boxes B1, B2, and B3 for which a plurality of image processing operations are predetermined.

In this example, if some of the image processing operations predetermined for these Boxes are common, no data sections showing results of the common image processing operations are displayed while data sections showing results of the other image processing operations which are different among the Boxes are displayed as preview images.

For example, the Boxes can be defined as follows:

[1] The Box B1 stores target data objects for internal use. Giving a ground pattern repeating “Copy” to the entire page Pw and a watermark stating “Confidential” to the upper right region of page Pr are the image processing operations predetermined for the Box B1.

[2] The Box B2 is for conservation. Giving a ground pattern repeating “Copy” to the entire page Pw and a file number “XXX-0102” to the bottom region of page Pu are the image processing operation predetermined for the Box 2.

[3] The Box B3 stores target data objects not for internal use. Giving a ground pattern repeating “Copy” to the entire page Pw and giving a company name to the bottom region of page Pu are the image processing operations predetermined for the Box B3.

The image processing operations predetermined for the Boxes B1, B2, and B3 are performed when a target data object is stored thereon, respectively.

In this example, only the data sections showing results of the image processing operations which are different among the Boxes are displayed as preview images. In other words, giving a ground pattern to the entire page Pw is an image processing operation which is common among all the Boxes. Although there would be definitely a data section changed by that operation, the data section is not extracted.

More specifically, as illustrated in FIG. 5, when a target data object is stored on the Box B1, a data section showing the string “Confidential” in the top right region Pr at a higher magnification is displayed as a preview image. When a target data object is stored on the Box B2, a data section showing a file number in the bottom region Pu is displayed as a preview image. When a target data object is stored on the Box B3, a data section showing a company name in the bottom region Pu is displayed as a preview image.

As described above, in this mode of implementation, data sections showing results of image processing operations which are different among the Boxes are displayed as preview images, which would make it easier for user to recognize changes.

FIG. 6 is an example illustrating preview images to be displayed when data sections to preview are specified by user. User is allowed to specify data sections to preview via the operation panel 11.

For example, when user specifies a watermark, only a data section showing a watermark among data sections changed is extracted and displayed as a preview image.

As described above, user is allowed to edit preview images as he/she likes, for example display only preview images that he/she wants to see.

In the mode of implementing the present invention described above, by the control of the CPU 11 of the MFP, data sections changed by a plurality of image processing operations are automatically extracted and displayed all together in a list form as preview images. Actually, there are users who want to see hidden preview images as well and see only preview images related to a particular address and/or Box while hiding the others.

Users therefore may configure the MFP so as to redisplay hidden preview images and hide unnecessary preview images, by touching a touch-panel screen of the display 112 or using an additional operating tool to operate the touch-panel screen such as a mouse.

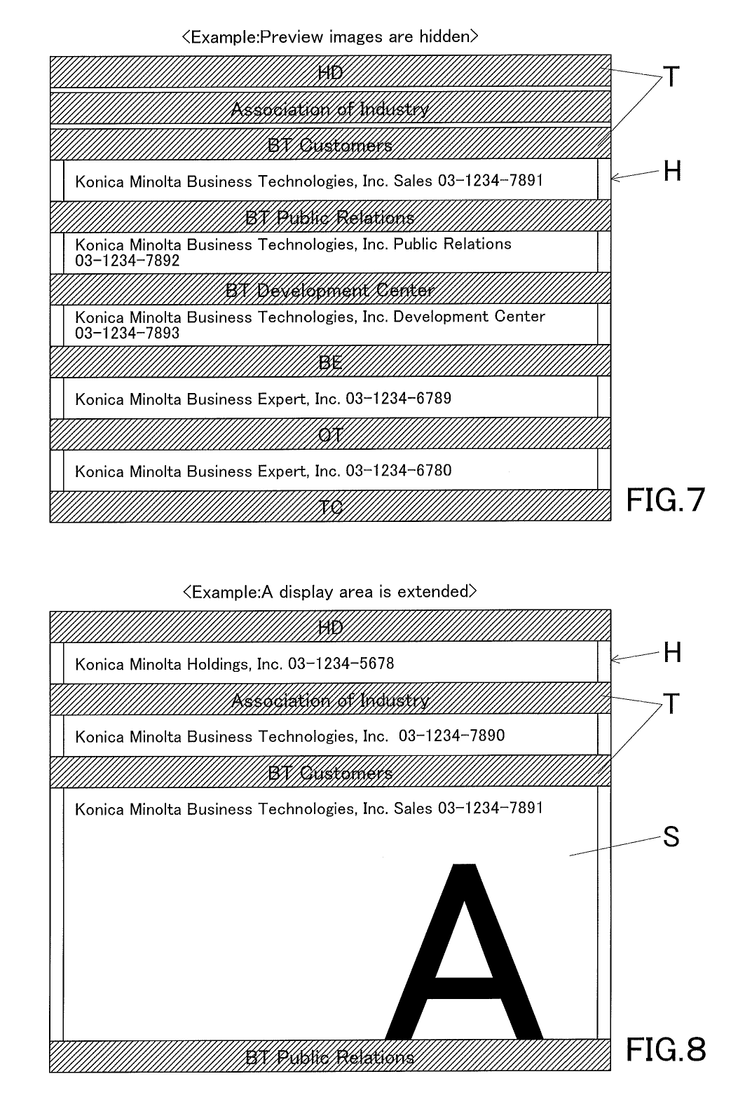

Users also may configure the MFP to extend and reduce a display area S showing a preview image. For example, as illustrated in FIG. 7, preview images may be hidden and redisplayed by touching their title lines; alternatively, preview images may be hidden by touching their display areas S and redisplayed by touching their title lines.

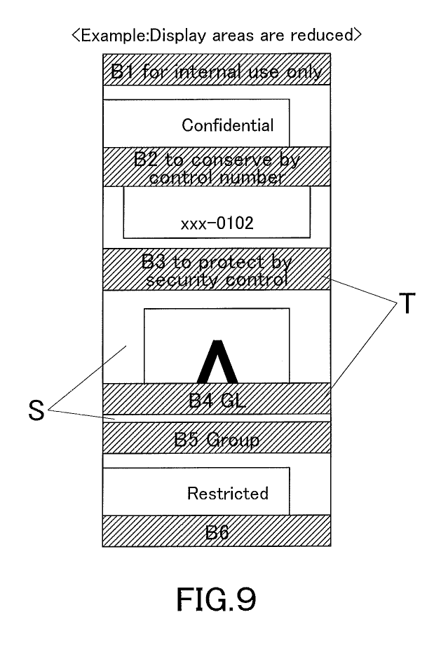

By sliding the boundary lines with the title lines, display areas S showing preview images may be extended as illustrated in FIG. 8 and reduced as illustrated in FIG. 9.

One mode of implementing the present invention has been described in the foregoing specification, which does not mean that the present invention shall be construed as limited to the particular forms disclosed. For example, in this mode of implementation, an image data object is given to a target data object by an image processing operation. The image processing operation may be any of the following operations: an N-in-1 printing for outputting N pages of a target data object on 1 page; a both/single-sided printing for outputting a target data object on single-sided or both-sided pages; an image formatting for copying a specified part, removing the frame, shifting the position of a target data object; an image hiding; and a paper finishing for stapling and punching printed paper. All the same as the mode of implementation described above, when a plurality of such image processing operations are performed on a target data object, data sections changed by the image processing operations are extracted from the original image and displayed all together as preview images.

The present invention having been described above may be applied to the following modes.

[1] An image processing operation comprising:

an image processor which performs a plurality of image processing operations on one target data object separately;

a display; and

a controller which extracts from the target data object a plurality of data sections changed by the image processing operations of the image processor and displays the extracted data sections on the display all together as preview images.

[2] The image processing apparatus as recited in the aforementioned item [1], wherein the controller adjusts a display area showing a preview image depending on the extracted data section.

[3] The image processing apparatus as recited in the aforementioned item [1] or [2], wherein the controller displays a part which is not common to all the extracted data sections, on the display as a preview image.

[4] The image processing apparatus as recited in the any of the aforementioned items [1] to [3], further comprising an instruction portion which allows user to specify a data section to preview, wherein the controller extracts the data section specified by user via the instruction portion and displays the extracted data section on the display as a preview image.

[5] The image processing apparatus as recited in any of the aforementioned items [1] to [4], wherein the controller adjusts a display area showing a preview image according to user instructions entered via a display screen.

[6] A preview image displaying method for an image processing apparatus, comprising:

performing a plurality of image processing operations on one original image separately; and

extracting from the original image a plurality of data sections changed by the image processing operations of the image processor and allowing previewing the extracted data sections on a display all together.

[7] A non-transitory computer-readable recording medium with a preview image displaying program being stored on an image processing apparatus to make a computer of the image processing apparatus execute:

performing a plurality of image processing operations on one original image separately; and

extracting from the original image a plurality of data sections changed by the image processing operations of the image processor and allowing previewing the extracted data sections on a display all together.

According to the invention in the aforementioned item [1], when a plurality of image processing operations are performed on one target data object separately, data sections changed by the image processing operations are extracted from the target data object and displayed all together, for example in an accordion structure, on a display as preview images.

As described above, the image processing apparatus is allowed to extract from the original image only data sections changed and display them all together as preview images. Therefore, it would not be necessary any more to repeat the following actions for all the image processing operations: selecting a preview image; viewing it at a higher magnification; and returning to select another preview image. That would make it easier for user to preview images and recognize changes about all the image processing operations.

Furthermore, displaying only the data sections changed would allow more preview images in a limited display area and ensure a good visibility unlike the case in which thumbnails showing entire documents are too small. That would make it easier for user to preview images and recognize changes about all the image processing operations.

According to the invention in the aforementioned item [2], the image processing apparatus is allowed to display data sections as preview images in a condition suitable for the position and size of the data section.

According to the invention in the aforementioned item [3], the image processing apparatus is allowed to display a part which is not common to all the extracted data sections, as a review image, which would make it easier for user to recognize changes.

According to the invention in the aforementioned item [4], the image processing apparatus is allowed to extract data sections specified by user and display them all together on the display as preview images. According to the invention in the aforementioned item [5], the image processing apparatus is allowed to: display and hide a specific preview image; and extend and reduce a display area showing a preview image, according to user instructions entered via a display screen.

According to the invention in the aforementioned item [6], the preview image displaying method allows an image processing apparatus to display a plurality of data sections changed by image processing operations, all together as preview images. Therefore, it would not be necessary any more to repeat the following actions for all the image processing operations: selecting a preview image; viewing it at a higher magnification; and returning to select another preview image. That would make it easier for user to preview images and recognize changes about all the image processing operations. Furthermore, displaying only the data sections changed would allow more preview images in a limited display area and ensure a good visibility unlike the case in which thumbnails showing entire documents are too small. That would make it easier for user to preview images and recognize changes about all the image processing operations.

According to the invention in the aforementioned item [7], a computer allows an image processing apparatus to display a plurality of data sections changed by image processing operations, all together on a display as preview images.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image processing apparatus comprising:
an image processor which performs a plurality of image processing operations on one target data object separately;
a display; and
a controller which extracts from the target data object a plurality of data sections changed by the image processing operations of the image processor and displays the extracted data sections all together on the display as preview images.

2. The image processing apparatus as recited in claim 1, wherein the controller adjusts a display area showing a preview image depending on the extracted data section.

3. The image processing apparatus as recited in claim 1, wherein the controller displays a part which is not common to all the extracted data sections, on the display as a preview image.

4. The image processing apparatus as recited in claim 1, further comprising an instruction portion which allows user to specify a data section to preview, wherein the controller extracts the data section specified by user via the instruction portion and displays the extracted data section on the display as a preview image.

5. The image processing apparatus as recited in claim 1, wherein the controller adjusts a display area showing a preview image according to user instructions entered via a display screen.

6. A preview image displaying method for an image processing apparatus, comprising:
performing a plurality of image processing operations on one original image separately; and
extracting from the original image a plurality of data sections changed by the image processing operations of the image processor and displaying the extracted data sections all together on a display as preview images.

7. The preview image displaying method as recited in claim 6, wherein a display area showing a preview image is adjusted depending on the extracted data section.

8. The preview image displaying method as recited in claim 6, wherein a part which is not common to all the extracted data sections is displayed on the display as a preview image.

9. The preview image displaying method as recited in claim 6, further comprising allowing user to specify a data section to preview, via an instruction portion, wherein the data section specified by user via the instruction portion is extracted and displayed on the display as a preview image.

10. The preview image displaying method as recited in claim 6, wherein a display area showing a preview image is adjusted according to user instructions entered via a display screen.

11. A non-transitory computer-readable recording medium with a preview image displaying program being stored on an image processing apparatus to make a computer of the image processing apparatus execute:
performing a plurality of image processing operations on one original image separately; and
extracting from the original image a plurality of data sections changed by the image processing operations of the image processor and displaying the extracted data sections all together on a display as preview images.

12. The non-transitory computer-readable recording medium as recited in claim 11, wherein a display area showing a preview image is adjusted depending on the extracted data section.

13. The non-transitory computer-readable recording medium as recited in claim 11, wherein a part which is not common to all the extracted data sections is displayed on the display as a preview image.

14. The non-transitory computer-readable recording medium as recited in claim 11, further comprising allowing user to specify a data section to preview, via an instruction portion, wherein the data section specified by user via the instruction portion is extracted and displayed on the display as a preview image.

15. The non-transitory computer-readable recording medium as recited in claim 11, wherein a display area showing a preview image is adjusted according to user instructions entered via a display screen.
